(19) United States
(12) Patent Application Publication
(10) Pub. No.: US 2026/0101260 A1
(43) Pub. Date: Apr. 9, 2026

(54) METHOD FOR EXCHANGING FUNCTIONALITY INFORMATION BETWEEN UE AND NETWORK

(71) Applicant: SHARP KABUSHIKI KAISHA, Sakai City (JP)

(72) Inventors: Rudraksh Shrivastava, Erligheim (DE); Sudeep Hegde, Stuttgart (DE); Tomoki Yoshimura, Camas, WA (US); Sangkyu Baek, Vancouver, WA (US)

(21) Appl. No.: 18/906,090

(22) Filed: Oct. 3, 2024

(51) Int. Cl. H04W 36/36; H04W 36/30

(52) U.S. Cl. CPC H04W 36/362; H04W 36/304

(57) ABSTRACT

A method, a base station (BS), and a user equipment (UE) for exchanging functionality information are provided. The method includes receiving cell information via a serving cell, the cell information comprising one or more network-side conditions and an associated identifier (ID) of at least one cell, evaluating one or more functionalities of the at least one cell based on the cell information, and reporting evaluation results of the one or more functionalities of the at least one cell to the serving cell.

### FIELD

The technology generally relates to wireless communications, and more particularly, to exchanging applicable functionality information.

### BACKGROUND

As the integration of artificial intelligence/machine learning (AI/ML) continues to expand in the 5^{th} generation (5G) New Radio (NR) networks, it has become crucial for User Equipment (UE) to accurately discern its serving and neighboring cells' AI/ML functionalities, for example, to ensure smooth handoffs, timely activation of relevant features, and efficient allocation of network resources. However, challenges emerge from dynamic network conditions, as the availability and capabilities of neighboring cells may vary due to factors such as traffic load and interference. In addition, the UE's own capabilities, internal conditions, model availability, and the inherent complexity of 5G NR networks (e.g., including integrated access and backhaul (IAB) systems) further complicate this assessment. To accurately determine the applicable functionalities of neighboring base stations (e.g., next-generation Node Bs (gNBs)) and cells, the UE has to be provided with relevant network-side information, including the appropriate timing for assessing neighboring cell functionalities and the methods for reporting this information back to the network. Reporting neighboring cell AI/ML functionality information may introduce signaling overhead that may affect network performance.

Therefore, there is a need in the art to develop efficient methods for accurately determining and reporting serving and neighboring cells' AI/ML functionalities, minimizing signaling overhead, ensuring the relevance of the information, and accommodating dynamic changes in network conditions and UE capabilities.

### SUMMARY

In a first aspect of the present application, a user equipment (UE) is provided. The UE includes one or more non-transitory computer-readable media storing one or more computer-executable instructions, and at least one processor coupled to the one or more non-transitory computer-readable media. The at least one processor is configured to receive cell information, via a serving cell, the cell information comprising one or more network-side conditions and an associated identifier (ID) of at least one cell, evaluate one or more functionalities of the at least one cell based on the cell information, and report evaluation results of the one or more functionalities of the at least one cell to the serving cell.

In an implementation of the first aspect, the at least one processor is further configured to execute the one or more computer-executable instructions to cause the UE to receive one or more functionality key performance indicator (KPI) thresholds associated with the one or more functionalities of at least one cell, determine whether a reporting event is triggered based on at least one of the one or more functionality KPI thresholds, mobility scenarios, and UE-specific parameters, scenarios and conditions, where the reporting of the evaluation results is in response to the reporting event being triggered.

In another implementation of the first aspect, the one or more functionality KPI thresholds comprise artificial intelligence/machine learning (AI/ML) functionality KPI thresholds.

In another implementation of the first aspect, the evaluation results of the one or more functionalities are reported to the serving cell in response to a change in an observed artificial intelligence/machine learning (AI/ML) functionality KPI range.

In another implementation of the first aspect, the at least one processor is further configured to execute the one or more computer-executable instructions to cause the UE to, prior to receiving the cell information, send a measurement report to the serving cell in response to a triggering event.

In another implementation of the first aspect, the measurement report includes measurements of channel quality of the at least one cell.

In another implementation of the first aspect, the evaluation results of the one or more functionalities are reported to the serving cell in response to a measurement parameter of the serving cell falling below a first threshold, or a measurement parameter of the at least one cell exceeding a second threshold.

In another implementation of the first aspect, the at least one cell comprises the serving cell.

In another implementation of the first aspect, the at least one cell comprises a neighboring cell.

In another implementation of the first aspect, the cell information further comprises one or more functionality configurations of the at least one cell.

In another implementation of the first aspect, the UE evaluates the one or more functionalities of the at least one cell based on at least one of: one or more functionality KPI thresholds, one or more associated IDs, the one or more network-side conditions, functionality or inference configurations, the UE's internal parameters, and model availability.

In another implementation of the first aspect, the evaluation results comprise an indication of whether at least one of the one or more functionalities is a functionality applicable for the at least one cell.

In another implementation of the first aspect, the at least one processor is further configured to execute the one or more computer-executable instructions to cause the UE to receive one or more functionality key performance indicator (KPI) thresholds associated with the one or more functionalities of at least one cell, evaluate one or more functionality KPI thresholds, and accept or reject the one or more functionality KPI thresholds based on the evaluation.

In another implementation of the first aspect, the at least one processor is further configured to execute the one or more computer-executable instructions to cause the UE to monitor a functionality KPI range of at least one of the one or more functionalities.

In a second aspect of the present application, a method by a user equipment (UE) is provided. The method includes receiving cell information via a serving cell, the cell information comprising one or more network-side conditions and an associated identifier (ID) of at least one cell, evaluating one or more functionalities of the at least one cell based on the cell information, and reporting evaluation results of the one or more functionalities of the at least one cell to the serving cell.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, in accordance with an example implementation of the present disclosure.

FIG. 2 illustrates a schematic signal flow diagram for functionality reporting, according to a reporting procedure.

FIG. 3 illustrates a schematic signal flow diagram between a UE and a source BS/cell for evaluating and reporting functionalities, in accordance with an example implementation of the present disclosure.

FIG. 4 illustrates a schematic signal flow diagram among a UE, a source BS/cell, and a neighboring BS/cell for evaluating and reporting functionalities, in accordance with an example implementation of the present disclosure.

FIG. 5 illustrates a flowchart of a method/process performed by a UE for evaluating and reporting functionalities based on cell information, in accordance with an example implementation of the present disclosure.

FIG. 6 is a flowchart diagram illustrating a method/process performed by a UE for identifying and reporting functionalities based on cell information, in accordance with an example implementation of the present disclosure.

FIG. 7 is a flowchart diagram illustrating a method/process performed by a UE for identifying and reporting functionalities for one or more neighboring cells based on cell information, in accordance with an example implementation of the present disclosure.

FIG. 8 is a flowchart diagram illustrating a method/process performed by a UE for independently reporting signal quality and applicable functionalities, in accordance with an example implementation of the present disclosure.

FIG. 9 is a block diagram illustrating a node for wireless communication, in accordance with an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel typically includes several antenna elements. A beam can be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-) configuration. If the firstActiveUplinkBWP IE field is absent, the RRC (re-) configuration may not impose a BWP switch. If the first active uplink BWP is configured for an SCell, the firstActiveUplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.

Panel: The UE panel information may be derived from the TCI state/UL beam indication information or from the network signaling.

Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).

TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.

TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.

TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.

Frequency Division Multiplexing (FDM) based PDSCH repetition: Multiple PDSCHs with the same TB but corresponding to two TCI states. These PDSCHs are allocated to non-overlapping frequency resources within a slot.

Multi-DCI based PDSCH scheme: Two PDCCHs from separate search spaces associated with different CORESET pool indexes that schedule the corresponding PDSCHs.

Single Frequency Network (SFN) based PDCCH scheme: A CORESET is associated with two different beams.

SFN based PDSCH scheme: A PDSCH is associated with two different beams.

Measurement objects: A list of objects on which the UE shall perform the measurements. For intra-frequency and inter-frequency measurements, a measurement object indicates the frequency/time location and subcarrier spacing of the reference signals to be measured. Associated with this measurement object, the network may configure a list of cell specific offsets, a list of exclude-listed cells and a list of allow-listed cells. The exclude-listed cells are not applicable in event evaluation or measurement reporting. The allow-listed cells are the only cells that are applicable in event evaluation or measurement reporting.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication”. The “DL only” and “UL only” may also be referred to as a “separate TCI state,” as opposed to the “joint TCI state”.

Unified TCI states may be indicated through an RRC message, a Medium Access Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:
Single DCI based TDM PDSCH repetition;
Single DCI based FDM PDSCH repetition;
Multi-DCI based PDSCH;
TDM PDCCH repetition;
FDM PDCCH repetition;
Single DCI based TDM PUSCH repetition;
TDM PUCCH repetition;
SFN based PDCCH scheme;
SFN based PDSCH scheme;
Single DCI based FDM PUSCH repetition;
Multi-DCI based PUSCH;
FDM PUCCH repetition;
SFN based PUSCH scheme; and
SFN based PUCCH scheme.

When the unified TCI framework is applied to at least one multi-TRP scheme, some changes may be needed. The changes may include the association between the unified indication and at least one TRP, the mapping order of the indicated TCI states, the association between the unified indication and the respective channel, and/or the method of signaling for each channel. In the present disclosure, implementations for applying the unified TCI framework to the multi-TRP scheme are disclosed hereinafter.

The 3GPP (e.g., as indicated in Release 18, study item (SI) on artificial intelligence/machine learning (AI/ML) for air interface) has identified the following scopes: (i) identify use cases and scenarios where the AI/ML may be effectively applied within the 3GPP-defined network architectures and protocols, (ii) study the integration of the AI/ML algorithms into the network functions, protocols, and management systems to enable intelligent decision-making and automation, and (iii) evaluate the impact of the AI/ML on the network scalability, reliability, energy efficiency, spectral efficiency, and quality of service.

For an AI/ML based beam management (BM) use case, the following two use cases may be selected, as the representative AI/ML sub-use cases. The first use case (BM-Case1) may include spatial-domain downlink beam prediction for a first set of beams (e.g., Set A of beams) based on measurement results of a second set of beams (e.g., Set B of beams).

For the BM-Case1, the following alternatives may be considered. The AI/ML model training and inference may be done either at the NW side or at the UE side. Set A and Set B may be different (e.g., Set B may not be a subset of Set A) or Set B may be a subset of Set A. It should be noted that Set A is for DL beam prediction. The codebook construction of Set A and Set B may be later defined.

The AI/ML model input may consider the following alternatives: (1) The layer 1 reference signal reception power (L1-RSRP) measurement based on Set B, the L1-RSRP measurement based on Set B and assistance information, the channel impulse response (CIR) based on Set B, or the L1-RSRP measurement based on Set B and the corresponding DL Tx and/or Rx beam ID.

The second use case (BM-Case2) may include temporal downlink beam prediction for Set A of beams based on the historic measurement results of Set B of beams. For the BM-Case2, the following alternatives may be considered. The AI/ML model training and inference may be done either at the NW side or at the UE side. Set A and Set B of beams may be different (e.g., Set B may not be a subset of Set A), Set B may be a subset of Set A (e.g., Set A and Set B may not be the same), or Set A and Set B are the same.

The AI/ML model input may consider measurement results of K (K≥1) latest measurement instances with the following alternatives: (1) Only the L1-RSRP measurements based on Set B, (2) The L1-RSRP measurements based on Set B and assistance information, or (3) The L1-RSRP measurements based on Set B and the corresponding DL Tx and/or Rx beam identification (ID). F predictions for F future time instances may be obtained based on the output of the AI/ML model, where each prediction is for each time instance. F may, at least be equal to 1.

Based on the parameters like report of the predicted top-K beam IDs, report of the predicted and/or actual/measured L1-RSRPs associated with the predicted top-K beams, report of the quantities indicating the confidence level of predictions for the top-K beams (e.g., the standard deviation of the predicted L1-RSRPs or statistics of the past RSRP measurements as a proxy for the confidence level of the predictions) and other related parameters like key performance indicators (KPIs), the AI/ML model may provide output in the form of F(f1, f2 . . . fn) predictions for T(t1, t2, . . . tn) future time instances. The prediction may reflect predicted beams and their corresponding configurations.

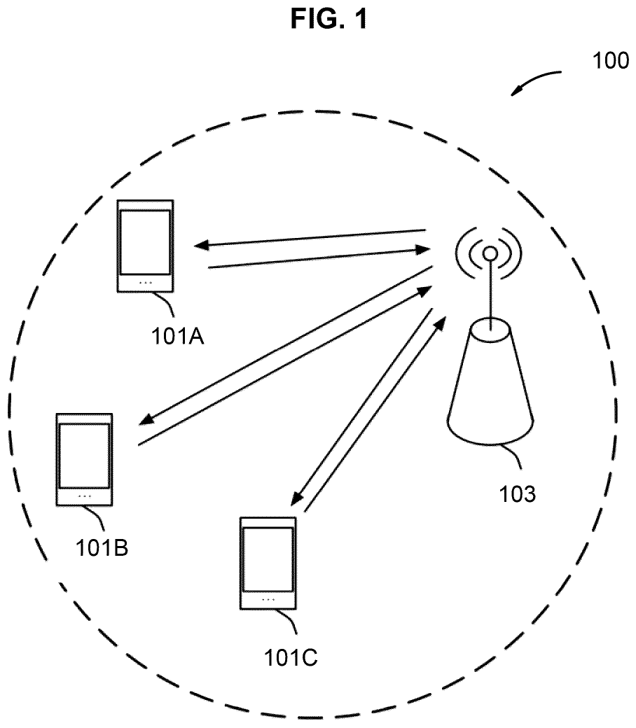

FIG. 1 is a schematic diagram illustrating a radio communication system 100, in accordance with an example implementation of the present disclosure. In FIG. 1, the radio communication system 100 includes the terminal devices 101A, 101B, and 101C and the base station device 103 (BS 103). The terms base station device, base station, and BS herein may be used interchangeably. The terms terminal device, user equipment, and UE herein may be used interchangeably.

BS 103 may include one or more transmission/reception devices. When BS 103 is configured with multiple transmission/reception devices, each of the multiple transmission/reception devices may be arranged at a different position. A transmission/reception device may include a transmission device and/or a reception device.

BS 103 may serve radio communication and provide one or more cells. A cell is defined in this disclosure, as a set of resources used for a wireless communication. A cell may include one or both of a downlink component carrier and an uplink component carrier. A serving cell may include a downlink component carrier and two or more uplink component carriers.

The BS 103, or another network entity, such as a location management function (LMF) server, in some embodiments, may provide multiple sets of configurations to the UE 101A-101C for a given AI/ML functionality. The BS 103, or the other network node, may provide a mechanism to change the configuration sets based on changes in the UE's environment and/or additional conditions.

In a wireless communication system, the RRC configuration process is necessary for setting up, maintaining, and modifying the radio connection between the UE and the BS (e.g., a gNB) in the 5G/5G-Advanced (5G-A) networks. The BS 103 or the network entity, may send an RRC message to a UE 101A/101B/101C to configure at least one of the configuration parameters or features of a configuration set. This RRC message may be, for example, RRCSetup, RRCReconfiguration, RRCResume, RRCRelease, or other downlink messages generated by the BS 103 or another network entity. The BS 103 and/or the other network entities are considered as components of the network. In the following discussions, the term network, or network node, refers to any network entity, such as, BS (e.g., gNB), LMF server, etc., and the BS 103 may be used as an example of such network node.

The term “configuration,” herein, may refer to the arrangement and specification of components, settings, or parameters within a system or device, as defined by the applicable agreements, standards, or specifications. The term configuration may encompass the established setup and customization of elements necessary to ensure compliance with contractual obligations, operational requirements, and performance criteria.

The network (e.g., the BS 103), in some embodiments, may configure measurement report triggering criteria and corresponding reporting to enable the UEs (e.g., the UEs 101A-101C) to consider predictions and inferences which may primarily be derived based on the measurement results (e.g. SINR, RSRP, Reference Signal Receiving Quality (RSRQ), etc.) for the purposes of UE mobility in the cellular networks. It is considered that the UE may have the relevant inference data/information available through AI/ML functionalities/models, as configured by the network (either the UE-sided model or the network-sided model), at the time of evaluation of the reporting criteria. In the examples discussed below, the UE may not provide the inference-related information to the network beforehand as the additional triggering conditions may not yet be satisfied. However, the provided solutions do not prevent the UE from doing so.

The disclosed configuration may allow the UE to compare the prediction or inference-based data relevant for mobility, as configured by the network, which may be derived by the processing of actual measurement results using AI/ML models/functionalities, as allowed by the network, with the actual (or legacy) measurement results obtained by receiving reference signals on the physical layer. The UE may also compare one set of prediction or inference-based data with another set of prediction or inference-based data. The prediction or inferences of measurements may also consider other parameters available to the UE (telemetric data, battery status etc.), either independently or jointly with the other relevant parameters.

The aforementioned comparison may consider measurements and relevant predictions/inferences from the currently serving network entity (e.g., BS, cell, relay, etc.), as well as the detected neighboring entity (e.g., BS, cell, relay, etc.), or a combination thereof.

The configuration of the report triggering criteria may take place utilizing the RRC signaling from the BS to the UE, for example, using the disclosed sub-elements within the RRC IE EventTriggerConfig, or as a new RRC IE, that may be introduced in the 3GPP specification, for the purpose of AI/ML-based UE mobility.

The RRC signaling received from the network entity may include the RRC Setup, RRC Reconfiguration, RRC Resume, RRC Release, etc. The UE may confirm the activation of the relevant measurement reporting configurations using the corresponding RRC message, such as RRC Setup Complete, RRC Reconfiguration Complete, etc. Upon the detection of the measurement reporting events based on the configured report triggering criteria, the UE may generate an appropriate report and may transmit the generated report to the network using, e.g., the RRC signaling.

According to implementations of the present disclosure, supported functionalities can refer to functionalities that UE can indicate by using UE capability information (via radio resource control (RRC)/Long-Term Evolution (LTE) Positioning Protocol (LPP) signaling). Applicable functionalities can refer to functionalities that the UE is ready to apply for inference. Activated functionalities can refer to functionalities already enabled for performing inference.

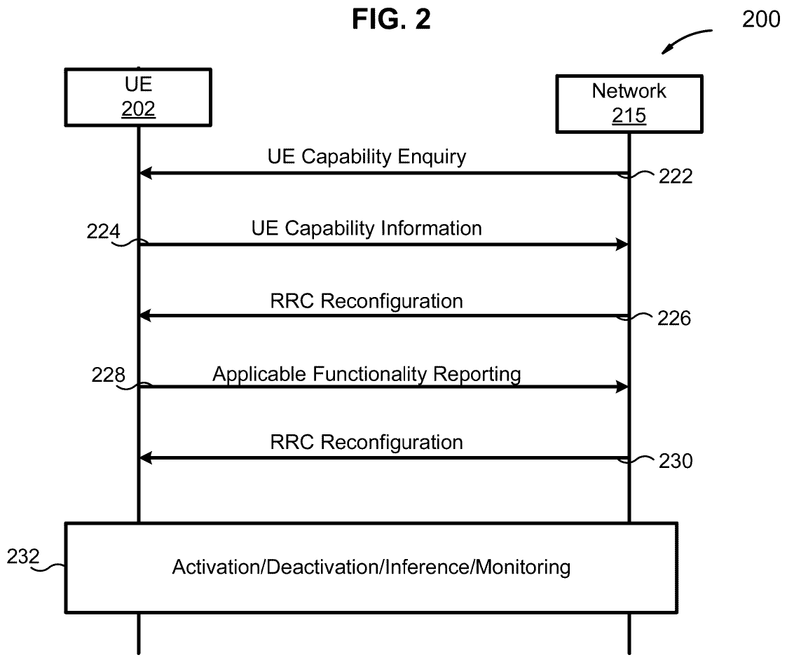

FIG. 2 illustrates a schematic signal flow diagram 200 for applicable functionality reporting, according to a reporting procedure. As illustrated in the signal flow diagram 200, in step 222, a network 215 sends a UE capability enquiry message (e.g., UECapabilityEnquiry) to initiate the procedure for a UE 202 to report its supported functionalities. In step 224, the UE 202 sends a UE capability information message (e.g., UECapablityInformation) to the network 215, the UECapablityInformation message containing supported functionalities on the UE side.

In step 226, the network 215 sends an RRC reconfiguration message (e.g., RRCReconfiguration) to the UE 202. The RRCReconfiguration message includes configurations to the UE 202 to perform UAI reporting, for example, via OtherConfig. In step 226, the network 215 may also provide network-side additional conditions and other configurations (e.g. inference configuration) of supported functionalities to the UE 202. In some implementations, after receiving the configurations in step 226, the UE 202 can determine the applicable functionalities based on the network-side additional conditions (if provided), UE-side additional conditions (internally known by the UE), and model availability.

In step 228, the UE 202 reports the applicable functionalities to the network 215. For example, the UE 202 can report the applicable functionalities upon being configured to provide applicable functionalities and upon change in applicable functionalities via UAI. In another example, the UE 202 can report the applicable functionalities in response to the network-side additional conditions requesting applicable functionality reporting in step 226.

In step 230, the network 215 sends another RRC reconfiguration message (e.g., RRCReconfiguration) to the UE 202. The network 215 configures one or more inference configurations to the UE 202 after the applicable functionality reporting in step 228, if an inference configuration based on a supported functionality is not provided in step 226. Hence, one or more inference configurations are provided in step 230. If an inference configuration based on a supported functionality is provided in step 226, it may be up to network implementation to decide whether to provide an updated configuration or not. In step 232, the UE 202 and/or the network 215 can activate, deactivate, infer, and/or monitor the applicable functionalities.

The current mobility mechanisms (e.g., in the 3GPP TS 38.300 and TS 38.331, the contents of which are incorporated by reference herein in their entirety) are aided by UE measurement reports, as configured by the network using RRC signaling. However, based on the current implementation of the 3GPP, the mobility events take into consideration only the available (legacy) measurement results based on signal or channel quality. The applicable functionality measurements and/or metrics are not considered for UE mobility in the current 3GPP specifications.

According to implementations of the present disclosure, a UE can perform source and neighboring cell measurements as part of the mobility management procedures in cellular networks to ensure that it maintains a reliable connection during mobility scenarios, such as a handover. These measurements help the network decide when to trigger a handover and which target cell to select.

The measurements include source (or serving) cell measurements and neighboring (or target) cell measurements. For example, the UE may continuously monitor and measure its current serving cell's signal or channel quality to ensure a stable connection. The UE may also measure signal or channel quality from its neighboring cells to determine if another cell provides better coverage or performance, which might warrant a handover.

According to implementations of the present disclosure, a UE can measure various radio link parameters to assess signal or channel quality. The measurement parameters include Reference Signal Received Power (RSRP), Reference Signal Received Quality (RSRQ), Signal-to-Interference plus Noise Ratio (SINR), and Synchronization Signal (SS)-RSRP, SS-RSRQ. For example, RSRP measures the power of the LTE/NR reference signal, and indicates the overall signal strength of the cell. RSRQ measures the signal quality, factoring in both signal strength and interference, and provides an indication of link quality. SINR is the ratio of signal power to interference and noise, where a higher SINR indicates better link quality. SS-RSRP and SS-RSRQ are NR specific metrics used for operating with millimeter waves (e.g., beams).

According to implementations of the present disclosure, a UE can perform measurements continuously while in a connected mode to ensure optimal network performance, regardless of mobility. When a UE is connected to a source cell, it may require measurement gaps to measure neighboring cells on different frequencies or bands. The measurement gaps are moments when data transmission is paused to allow the UE to measure other frequencies.

According to implementations of the present disclosure, a UE can report the measurements through enhanced periodic reporting or through a new event configured by the network. For example, the UE can send measurement reports to the serving (source) BS (e.g., a gNB in 5G NR or an eNB in LTE) based on pre-configured events and/or thresholds.

The existing mechanisms for the UE mobility in the 3GPP networks (e.g., handover) consider several measurement reporting events (e.g., legacy measurement reporting events), as specified in the 3GPP TS 38.331, with some examples listed below.

Event A1: Serving cell quality becomes better than a predefined threshold;

Event A2: Serving cell quality becomes worse than a predefined threshold;

Event A3: Neighboring cell quality becomes better than the serving cell;

Event A4: Neighboring cell quality becomes better better than an absolute threshold;

Event A5: Serving cell quality becomes worse than a first threshold, and the neighboring cell quality becomes better than a second threshold.

Other events, for example, as defined in the 3GPP TS 38.331 may also be included. The measurements and reports help the network decide when and where a handover should occur.

The serving BS (e.g., a gNB or an eNB) may configure the UE with a measurement configuration, which may specify what parameters the UE should measure (e.g., RSRP, RSRQ, and etc.) and what events may trigger a measurement reporting. The measurement configuration may also specify which cells (intra-frequency, inter-frequency, or inter-RAT) to measure, and may include parameters such as thresholds for reporting, periodicity, and measurement gaps.

The UE may continuously measure the signal or channel quality (e.g., RSRP, RSRQ, and etc.) of the source cell. Simultaneously, the UE may measure neighboring cells, either on the same frequency (intra-frequency) or on different frequencies (inter-frequency). For inter-frequency measurements, the UE may use measurement gaps to tune into other frequencies without affecting the ongoing connection.

Based on the measurement configuration, the UE evaluates whether certain conditions or events are met. For example, if the signal strength of a neighboring cell is greater than the serving cell (e.g., legacy Event A3 above), a handover may be considered. When a threshold is reached or exceeded, the UE sends a measurement report to the serving BS (e.g., a gNB or an eNB), indicating the conditions (e.g., the neighboring cell signal is stronger than the current cell signal). After receiving the measurement report, the network can decide whether and when a handover is necessary. If a target cell is chosen, the serving cell sends a handover command to the UE.

It is noted that the measurement and reporting can be performed in various frequency bands, including low-frequency bands (e.g., sub-6 GHz bands) and high-frequency bands (e.g., 24 GHz and above bands or mmWave bands).

Lower-frequency bands (e.g., 700 MHz to 2.6 GHZ) can provide better coverage but may have a lower data capacity. Measurements in these bands generally cover a larger area and require less frequent handovers due to better propagation characteristics. Higher-frequency bands (mmWave) have limited coverage and are more prone to signal blockages (e.g., buildings, obstacles, etc.). As a result, the UE may need to perform more frequent neighboring cell measurements to maintain connectivity. Measurement gaps for mmWave bands are more critical because handover decisions need to be more precise due to faster signal degradation.

In 5G NR, especially in high-frequency bands like mmWave bands, beam-based measurements are critical. The UE must measure the quality of different beams (beamforming) from the BS (e.g., a gNB) to ensure it is connected to the best beam. The UE reports the beam quality (e.g., RSRP, RSRQ, and etc.) back to the BS, and based on these reports, the BS can adjust the beam or switch to a different beam to maintain the best possible connection.

Under the current 3GPP framework, UEs can proactively or reactively identify applicable functionalities for the source BS. According to a proactive approach, a UE evaluates the applicability status (applicable or inapplicable) of the functionalities and possibly recommendations to the source BS (e.g. the recommended set(s) A/B) using UE additional (or internal) conditions and the AI/ML model(s) availability (and optionally using network-side additional conditions). The results of such evaluation are then transmitted to the source BS. According to a reactive approach, a UE evaluates the applicability status (applicable or inapplicable) of the functionalities for the source BS based on the configuration received from the source BS (e.g., in step 226 shown in FIG. 2), the UE additional (or internal) conditions, and the model(s) availability. The results of such evaluation are then transmitted to the source BS.

According to implementations of the present disclosure, the UE can determine source and neighboring cells' applicable functionalities based on:
(1) network-side additional conditions, for example, represented by associated IDs (e.g., per cell);
(2) functionality configurations (full or partial), provided by the source and/or neighboring cells;
(3) model(s) availability;
(4) UE-side internal conditions.

The network-side conditions may refer to the network-side additional conditions summarized by in 3GPP document R1-2405680, the content of which is incorporated by reference herein in its entirety.

The associated IDs may be associated with one or more of the following:
(1) mapping relationship of Set A and Set B, including ordering to (a set of ID, or resource);
(2) consistency of downlink spatial domaint transmission filters corresponding to the beams in Set A and Set B;
(3) Quasi-CoLocation (QCL) assumption;
(4) The order of model input and model output;
(5) between RS and Tx beams can be pre-defined;
(6) transmission power;
(7) UE distribution;
(8) antenna height;
(9) deployment scenarios (e.g., ISD, Urban Microcell (Umi)/urban microcell (Uma);
(10) ensure consistency across different cells.

Implementations of the present disclosure provide methods to facilitate the exchange of cell information (e.g., source and/or neighboring cells), such as associated IDs, network-side conditions, and functionality configurations (e.g., inference configurations, either full or partial), that allows a UE to identify and report applicable functionalities of one or more cells (e.g., source and/or neighboring cells). These methods enable the source BS (e.g., a gNB) to proactively prepare both the UE and the neighboring BSs/cells for potential events, such as handover, or in scenarios such as Handover Failure (HoF) and Radio Link Failure (RLF).

In some implementations, the neighboring BSs/cells can provide network-related conditions, associated IDs, network-side conditions, and/or inference configurations to the source BS/cell via a gNB-to-gNB interface (e.g., an Xn interface). Thereafter, the source BS/cell can transmit the relevant information, including network-side conditions, associated IDs, and inference configurations, to the UE through an RRC message, such as a Measurement Configuration message (e.g., MeasConfig). These enhancements to the RRC signaling are beneficial to functionality reporting. Other L1/L2/L3 signaling messages may also be employed for this purpose. The present disclosure also presents various methods for exchanging BS/cell functionality information between the UE and the network.

According to an aspect of the present disclosure, the network may configure one or more functionality triggering events (e.g., AI/ML functionality triggering events) and provide the configuration (e.g., having functionality events and related conditions) to the UE.

In one implementation, the network can configure various AI/ML functionality key performance indicator (KPI) thresholds, and/or conditions based on, for example, mobility scenarios, or UE-specific parameters, scenarios and conditions to the UE via the UE's serving BS/cell. The functionality KPI thresholds can be computed at the UE, or the network can provide the information to the UE. In one example, the UE can report the configured thresholds, conditions or values to the network, and the network can calculate the metrics. In another example, the UE can calculate the metrics and report the calculation results to the network. It is noted that the required functionality KPI thresholds can be configured in the form of events (e.g. measurement events). For example, moving from one functionality KPI threshold range to another can be considered an event.

In one implementation, the network can provide the UE with the associated IDs, network-side conditions, configurations (e.g., full or partial inference configurations), and other parameters (either before/during handover).

In one implementation, the UE can estimate a predicted functionality KPI threshold of a functionality based on each associated ID (and other related configurations) provided by the network.

In one implementation, the UE can report to the network the applicable functionalities (using, for example, functionality IDs), including the predicted functionality KPI thresholds/conditions (in the form of thresholds). The UE can report the applicable functionalities immediately after receiving the configurations (e.g., during a signaling handshake). The UE can also report the applicable functionalities every time the prediction threshold events are observed (event-based).

The following is an example of an event-based report:
1> if reportType is set to event Triggered or reportOnScellActivation or AI_activation (once applicable or no more applicable, based on associated ID);
   2> Report the corresponding response to applicable ID (the network will now know that the reported measurements are based on the applicable AI functionality) or that the UE is using a new AI configuration or no AI, and so on.

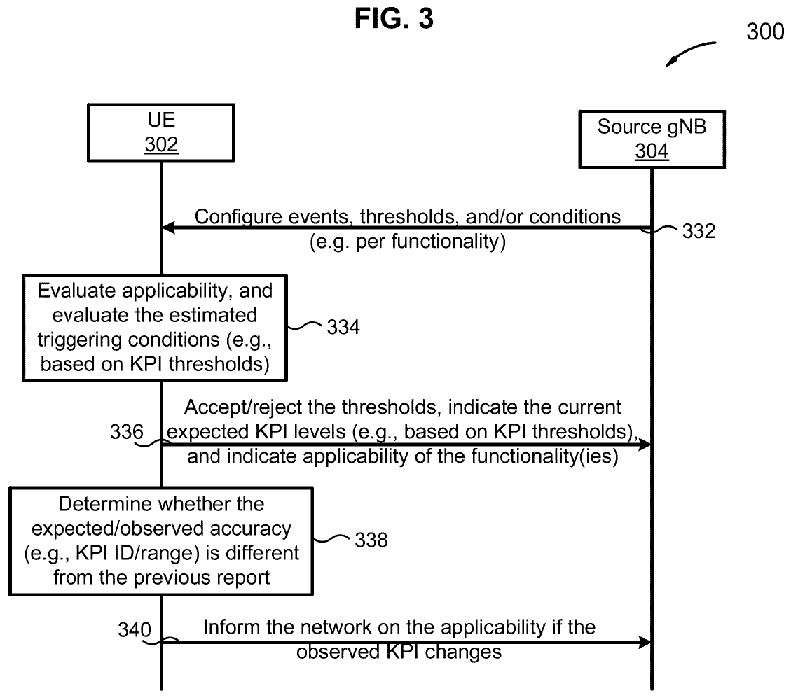

FIG. 3 illustrates a schematic signal flow diagram 300 between a UE 302 and a source (or serving) BS/cell 304 for evaluating and reporting applicable functionalities (e.g., using functionality IDs), in accordance with an example implementation of the present disclosure.

In step 332, the network configures various new events, thresholds, and/or conditions, based on, for example, AI/ML functionality KPI thresholds, mobility scenarios, and/or UE-specific parameters, scenarios and conditions, to the UE 302 via the UE's source BS/cell 304. The KPI thresholds may be provided per functionality or per model used within each functionality. The source BS/cell 304 may utilize existing RRC signaling with appropriate extensions to indicate the functionality KPI thresholds to the UE 302. The source BS/cell 304 may provide the required associated IDs and inference configurations related to the AI/ML functionality KPIs to be reported.

The following are example KPIs for beam management as a use case:
(a) predicted Top 1 or Top K beams, and ground truth of the target Set A resources (and at the target time instance(s) for BMcase-2);
(b) measured L1-RSRP of the configured resource(s);
(c) probability information of the predicted beam to be the Top 1;
(d) measured L1-RSRP and the predicted RSRP;
(e) measured [L1-] RSRP of current and predicted RSRP of the predicted Top 1 beam;
(f) measurement accuracy.
   It is noted that other KPIs for other use cases can be applicable and are not excluded.

As stated in the 3GPP TR 38.843, the following model monitoring KPIs are considered:
(a) accuracy and relevance (i.e., how well does the given monitoring metric/methods reflect the model and system performance);
(b) overhead (e.g., signaling overhead associated with model monitoring);
(c) complexity (e.g., computation and memory cost for model monitoring);
(d) latency (e.g., timeliness of monitoring result, from model failure to action, given the purpose of model monitoring).
   Relevant KPIs may vary across different model monitoring approaches. Hence, other KPIs for other use cases can be applicable and are not excluded. The content of the 3GPP TR 38.843 is incorporated by reference herein in its entirety.

As reported in TR 38.843, common KPIs may include:
(a) Performance:
   (i) Intermediate KPIs;
   (ii) Link and system level performance;
   (iii) Generalization performance;
(b) Over-the-air Overhead;
(c) Inference complexity, including complexity for pre- and post-processing;
(d) Training complexity;
(e) LCM related complexity and storage overhead.

The KPI thresholds and/or conditions may be configured based on the exemplary Table 1 below.

TABLE 1
KPI ID - KPI Value/Range Mapping Table

| KPI ID | KPI Value/Range |
|---|---|
| 1 | 25 to 50% |
| 2 | 50 to 75% |
| 3 | 75 to 95% |

Referring to FIG. 3, in step 334, after the UE 302 receives the configuration having the new events, thresholds and/or conditions from the source BS/cell 304, the UE 302 evaluates the applicability of each of the functionalities, where the evaluation may depend on the associated IDs and inference configurations provided by the source BS/cell 304, as well as the UE's internal parameters, the model availability, among others. The UE 302 also evaluates the estimated triggering conditions (e.g., KPI triggering conditions based on KPI thresholds).

In step 336, the UE 302 indicates the evaluation results to the network, for example, via the source BS/cell 304. For example, the UE 302 may report, for a given functionality, whether it accepts or rejects the new events, thresholds and/or conditions in the configuration provided by the network. The UE 302 may report whether the referenced functionalities are applicable for the UE 302 at the required KPI thresholds. The UE 302 may also report the current expected KPI levels based on the KPI thresholds (e.g., whether the expected KPI levels are already available). The UE 302 may transmit or report the above-mentioned information to the network using an appropriate RRC message.

In step 338, after the UE 302 is configured with the KPI thresholds as described above, the UE 302 continuously monitors the expected or observed KPI thresholds (or range(s)) for the configured functionalities to determine whether an expected or observed KPI ID/range is different from a previously reported KPI ID/range. If the observed KPI IDs/ranges deviate (e.g., improve or deteriorate) from the previously reported KPI IDs/ranges (e.g. in step 336), the UE 302 is configured to report to the network the newly observed KPI IDs/ranges in step 340.

In another implementation, an additional triggering condition may be that the current functionality KPIs are different as compared to the ones indicated in the last transmission of the functionality KPIs. For the change in functionality KPI, an ID can be configured as an event which can trigger the KPI-ID-modification report to be sent by the UE to the network.

The KPI thresholds observed by the UE are dependent on the availability of the associated IDs and inference configurations, as previously provided by the network. The observed KPI thresholds may be changed for example when a new associated ID and/or inference configuration(s) are provided to the UE. The KPI thresholds may also be dependent on UE-sided conditions, which may affect for example the functionality KPI thresholds with which the AI/ML model may be able to perform inference, for example, based on the available computational hardware, the UE battery status, among others.

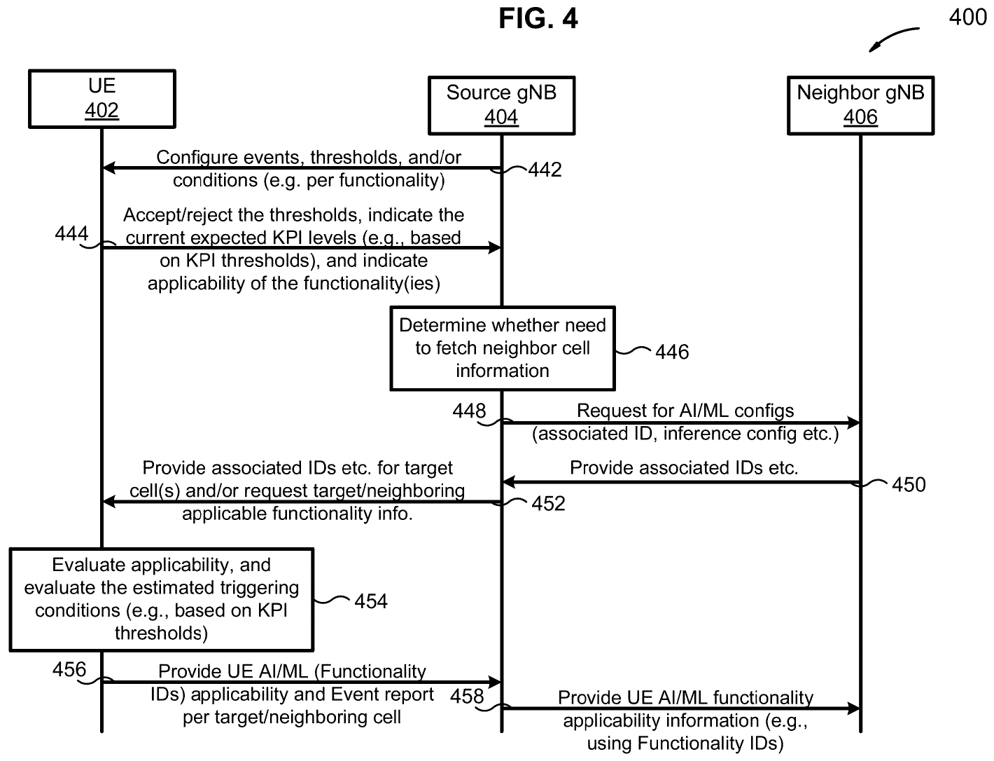

FIG. 4 illustrates a schematic signal flow diagram 400 among a UE 402, a source (or serving) BS/cell 404, and a neighboring (or target) BS/cell 406 for evaluating and reporting applicable functionalities for the neighboring BS/cell 406 via the source BS/cell 404, in accordance with an example implementation of the present disclosure.

In the present implementations, steps 442 and 444 may be substantially similar to steps 332 and 336, respectively, as shown and described in FIG. 3, the details of which are omitted for brevity.

It should be noted that between steps 442 and 444, the UE 402 may evaluate the applicability of each of the functionalities and the estimated triggering conditions (e.g., based on KPI thresholds) similar to step 334 as shown and described in FIG. 3, the details of which are omitted for brevity.

In step 446, the source BS/cell 404 determines if it needs to fetch neighboring cell information.

If the neighboring cell information is needed, in step 448, the source BS/cell 404 sends a request to the neighboring BS/cell 406 to fetch the neighboring cell information, including the associated ID of the neighboring BS/cell 406, network-side conditions, inference configurations, among others.

In step 450, the neighboring BS/cell 406 provides the requested information to the source BS/cell 404.

In step 452, the source BS/cell 404 provides the neighboring cell information (e.g., associated IDs, network-side conditions, etc.) to the UE 402. This may be used as an implicit indication for the UE to determine and report neighboring BS/cell applicable functionalities. In another implementation, the message in step 452 may include the request to determine and indicate neighboring BS/cell applicable functionalities to the network. In another implementation, a separate RRC message or any other L1/L2/L3 signaling message may be used by the network to request the UE 402 to report and indicate the neighboring BS/cell's applicable functionalities.

In step 454, after the UE 402 evaluates the applicability of each of the functionalities, where the evaluation may depend on the associated ID and inference configurations provided from the neighboring BS/cell 406, as well as the UE's internal parameters, the model availability, among others. The UE 402 also evaluates the estimated KPI thresholds.

In steps 456 and 458, the UE 402 indicates the evaluation results (e.g., the applicable functionalities and any events based on KPI thresholds/conditions) to the neighboring BS/cell 406 via the source BS/cell 404. For example, the UE 402 may report whether it accepts or rejects the functionality KPI thresholds of the neighboring BS/cell 406. The UE may report whether the referenced functionalities of the neighboring BS/cell 406 are applicable for the UE 402. The KPI thresholds can be considered as event-triggering conditions for the UE to report (e.g., in steps 456 and 458) to the network when triggered (in step 454), as mentioned in the examples herein (e.g. accept/reject or any change in applicability of the referenced functionality). The event report may include information on which functionality is applicable (or not), and for which cell, based on the appropriate event which triggers the event report.

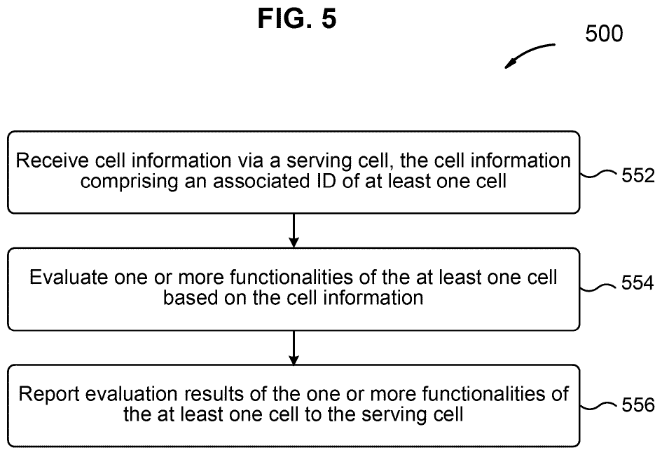

FIG. 5 illustrates a flowchart of a method/process 500 performed by a UE for identifying and reporting applicable functionalities based on cell information, in accordance with an example implementation of the present disclosure.

In step 552, the UE receives cell information, via a serving cell, cell information comprising associated IDs of one or more cells and network-side conditions. The cell information may also include new events, thresholds, conditions, and functionality configurations of the cell. In some implementations, step 552 may be substantially similar to step 332 in FIG. 3 or step 452 in FIG. 4, the details of which are omitted for brevity.

In step 554, the UE evaluates one or more functionalities of the at least one cell based on the cell information. For example, the UE may evaluate the applicability of each of the functionalities, where the evaluation may depend on the associated IDs and inference configurations provided by the source BS/cell, as well as the UE's internal parameters, the model availability, among others. The UE may also evaluate the estimated triggering conditions (e.g., based on KPI thresholds). In some implementations, step 554 may be substantially similar to step 334 in FIG. 3 or step 454 in FIG. 4, the details of which are omitted for brevity.

In step 556, the UE reports the evaluation results of the one or more functionalities of the at least one cell to the serving cell (e.g., using functionality IDs). In some implementations, step 556 may be substantially similar to step 340 in FIG. 3 or steps 456 and/or 458 in FIG. 4, the details of which are omitted for brevity.

In some implementations, the cell information may include source cell information and/or neighboring cell information of one or more neighboring cells. In some implementations, the cell information may include one or more associated IDs, network-side conditions, functionality configurations, functionality IDs. In some implementations, the cell information may include one or more functionality KPI thresholds associated with one or more functionalities of one or more cells.

Implementations of the present disclosure further describe the following scenarios for identifying and reporting source and/or neighboring cell applicable functionalities, for example, on a per cell basis.

According to a first scenario, the UE performs applicable functionality reporting independent of any potential triggering of legacy mobility events. According to this first scenario, a new functionality event (e.g., an AI/ML functionality event) is configured by the network. In the first scenario, the source BS/cell preemptively prepares the UE for identifying and reporting applicable functionalities (e.g., on a per cell basis), for example, independent of any potential triggering of legacy mobility events (e.g., legacy Events A3 and A5 above).

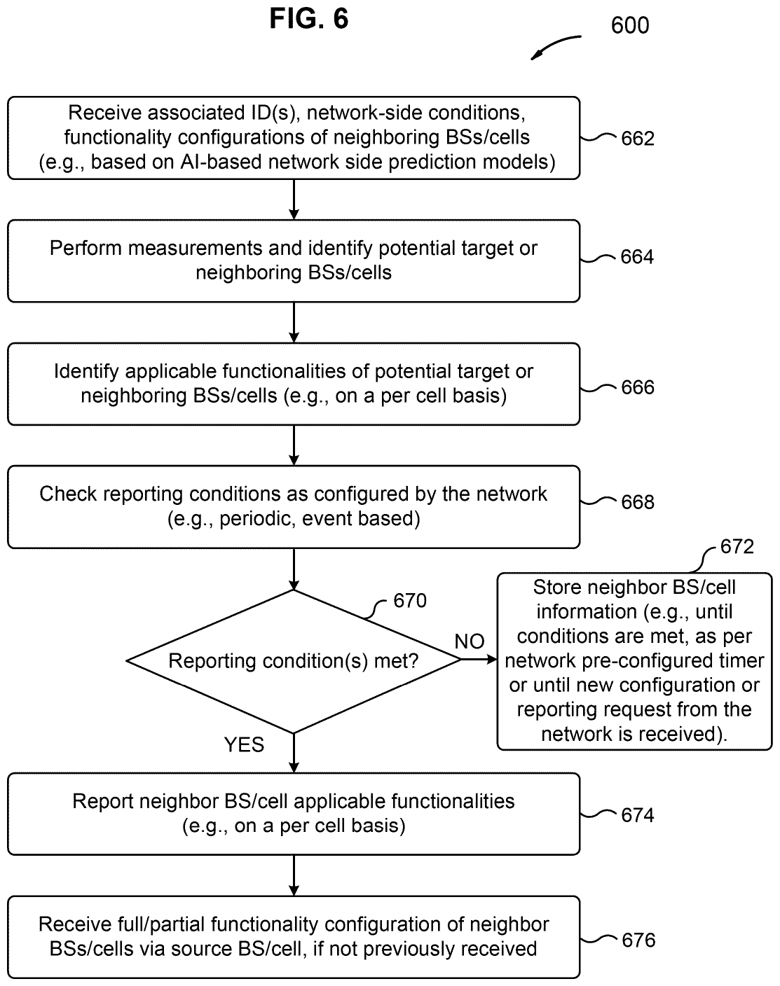

FIG. 6 is a flowchart diagram illustrating a method/process 600 performed by a UE for identifying and reporting applicable functionalities based on cell information, in accordance with an example implementation of the present disclosure.

As shown in FIG. 6, in step 662, the UE receives from the source BS/cell one or more associated IDs of one or more cells (e.g., source and neighboring cells) in an RRC message (e.g., in a MeasConfig message) or a new message. The UE also receives various new events, thresholds, and/or conditions, based on, for example, AI/ML functionality KPI thresholds, mobility scenarios, and/or UE-specific parameters, scenarios and conditions. In one implementation, step 662 may substantially correspond to step 332 in FIG. 3, the details of which are omitted for brevity. In the present implementation, the receipt of the configuration(s) in step 662 is independent of or prior to any legacy mobility events (e.g., Events A2, A3, A5, etc.).

In step 664, after the UE receives the associated ID(s) from the source BS/cell (or network), it performs measurements and identifies (or selects) potential target or neighboring BSs (e.g., gNBs). In step 666, the UE then identifies the applicable functionalities (functionality IDs) of each of the identified target or neighboring BSs/cells (e.g., on a per cell basis). In some implementations, steps 664 and 666 may substantially correspond to step 334 in FIG. 3 or step 454 in FIG. 4, the details of which are omitted for brevity.

In step 668, the UE checks the reporting conditions as configured by the network to determine the reporting conditions (e.g., event based or periodic).

In step 670, the UE determines whether one or more reporting conditions are met (e.g. in response to a report triggering event or based on a report periodicity).

In step 672, if a reporting condition is not met, the UE stores the neighboring cell report information, for example, until one or more reporting conditions are met, as per network pre-configured timer, or until a new configuration or reporting request from the network is received.

In step 674, if a reporting condition is met, the UE reports the applicable functionalities on a per cell basis to the source and/or neighboring BSs/cells, for example, using L1/L2 signaling, such as via RRC signaling.

In step 676, the UE receives full or partial functionality configurations of the neighboring BSs/cells via the source BS/cell, if the functionality configurations were not previously received (e.g., in step 662).

The method 600 illustrates a cell selection process that allows the UE to prioritize certain neighboring cells based on the associated IDs, network-side conditions, and AI/ML functionalities, independent of or in addition to the legacy measurements that the UE performs. This may help the UE and the network for potential mobility actions, such as handover and cell reselection, optimizing connectivity and network performance. The final selection is reported back to the serving BS for further action.

In some implementations, the UE can report the selection results (along with applicable functionalities) via a new RRC message, within enhanced measurement reporting, or extended UAI.

Upon receiving this information, the source/serving BS preemptively prepares a set of neighboring/target BSs for a mobility event (e.g., a handover) in anticipation of any measurement events or new AI/ML functionality related events being triggered.

The source BS may perform neighboring cell list update. For example, the source BS can update its internal neighboring cell list based on the reported signal quality and applicable functionalities of the neighboring BSs. As a result, the neighboring cell list includes the most recent or up-to-date information about the best beam(s) for each neighboring cell.

The source BS may perform UE context update. For example, the source BS can update the following:
UE Capability Information;
UE AI/ML applicable functionality source gNB;
UE AI/ML applicable functionality for identified neighbor gNBs;
UE AI/ML functionality configuration corresponding to the neighbor gNBs as obtained from the neighbor gNBs;
UE Capabilities: Includes radio access capabilities, which are reported during initial setup and handover processes;
Supported Frequency Bands: The frequency bands (e.g., n78, n41) supported by the UE;
Duplex Mode: Specifies if the UE supports FDD (Frequency Division Duplex) or TDD (Time Division Duplex);
Supported Modulation and Coding Schemes (MCS): Indicates maximum modulation schemes supported (e.g., 256-QAM);
Beam Management Capability: Describes the UE's ability to manage and switch beams;
Carrier Aggregation Support: Specifies the number and combination of carriers that the UE can aggregate.

In addition, the source BS can preemptively prepare for mobility events, such as new AI/ML functionality events, handovers, and radio link failures. For example, the source BS can start to prepare all or a subset of the neighboring BSs that were reported by the UE as having strong signal or channel quality and corresponding applicable functionalities.

The preparations performed by the source BS include, but are not limited to, context setup, bearer setup, and resource allocation. For example, the source BS can send the UE context (such as UE capabilities, RRC state, applicable functionalities (as identified by the UE) and security context) to all or a subset of the neighboring BSs in advance, even before any actual event is triggered. The source BS can also set up bearers (data channels) in the neighboring BSs, where the bearers can be activated, for example, in response to a mobility event (e.g., a handover) being triggered in the future. The source BS and/or the target/neighboring BSs can allocate necessary radio resources (e.g., physical resource blocks and beams) based on the UE's context.

In some implementations, the target/neighboring BS may provide full or partial AI/ML applicable functionality information to the UE such as inference configurations via the source BS/cell. In some implementations, the target/neighboring BS/cell may provide a default or preferred configuration that the UE may activate when an RRC connection with the target/neighboring BS/cell is established. In some implementations, the UE stores AI/ML functionality related information, such as associated IDs or network-side additional conditions of the source and neighboring BSs/cells, full or partial AI/ML functionality configurations of the source and target/neighboring BSs/cells. This AI/ML functionality related information can be stored until a new RRC reconfiguration message (e.g., a new MeasConfig message) is received by the UE from the source BS/cell.

### Iterating Over MeasIDs

For the signal quality and applicable functionality reporting, the UE iterates through each measurement ID (measId) in the measurement ID list (measIdList) contained in a measurement configuration (e.g., VarMeasConfig). For each measurement ID, the UE examines the corresponding report configuration (e.g., reportConfig) to determine the reporting type and measurement object (e.g., measObject).

For each measurement ID, the UE checks the measurement report type (reportType) in the report configuration. In one implementation, the measurement report type may include at least one of an event triggered measurement reporting (“eventTriggered”) and a periodical measurement reporting (“periodical”). If the report configuration of the current measurement ID specifies a report type (reportType) of “eventTriggered” or “periodical,” the UE may proceed to the next step.

According to implementations of the present disclosure, the report configuration can include a new report type for applicable functionality reporting (e.g., AI/ML applicable functionality reporting). The new report type can include at least one of an event triggered applicable functionality reporting (e.g., “AI/ML eventTriggered”) and a periodical applicable functionality reporting (e.g., “AI/ML periodical”). In another implementation, the applicable functionality report type may not be explicitly defined in the report configuration.

It should be noted that the applicable functionality reporting can be independent of the signal/channel quality measurement reporting (e.g., for legacy mobility events). Hence, the applicable functionality report (e.g., a AI/ML applicable functionality report) can be sent to the source BS/cell in a separate RRC message or via enhanced UAI.

According to one implementation, the report configuration can explicitly indicate the applicable functionality reporting to be periodic or event triggered. This would provide flexibility to have an event triggered applicable functionality reporting even in case of a periodic measurement reportType. According to another implementation, the report configuration may not include or explicitly define applicable functionality reporting or an applicable functionality reporting type. In such as case, the applicable functionality reporting can be set to be periodic. According to another implementation, if the reportType is different, the UE may skip this measId and moves on to the next one.

### Checking MeasObject

For the signal (or channel) quality and applicable functionality reporting, the UE also examines the measurement object (measObject). If the measurement object associated with the current measurement ID concerns New Radio, the UE continues with the subsequent steps associated with the current measurement ID. Otherwise, the UE skips to the next measurement ID.

### Checking ReportConfig and MeasRSSI-ReportConfig

For the signal quality and applicable functionality reporting, the UE also checks to determine whether the report configuration includes a measurement RSSI report configuration (measRSSI-ReportConfig).

If the reportConfig includes measRSSI-ReportConfig, the UE considers the resource indicated by the rmtc-Config on the associated frequency to be applicable, which means that the UE will report RSSI measurements for the specified resource.

If the reportConfig includes Event A1 or Event A2 above, the UE considers only the serving cell to be applicable, which means that the UE will report measurements only for the cell it is currently attached to.

If the reportConfig includes EventA3, EventA5, EventA3H1, EventA3H2, EventA5H1, EventA5H2, or the new event for applicable functionality reporting, then the UE determines whether the serving cell is associated with a measObjectNR and the neighboring cells are associated with another measObjectNR. If the serving cell is associated with a measObjectNR and the neighboring cells are associated with another measObjectNR, then the UE considers any serving cell associated with the other measObjectNR to be a neighboring cell as well. This expands the set of neighboring cells for measurement purposes.

It is noted that although measurement configuration (MeasConfig) and measurement report (MeasReport) messages are used to describe various example implementations in the present disclosure, other RRC messages, L1/L2/L3 messages, and other new messages can also be used for implementing the methods described in the present disclosure.

According to a second scenario, the UE performs applicable functionality reporting in response to a triggered legacy mobility event. In the second scenario, the source BS prepares the UE for the corresponding actions associated with the triggered legacy mobility event, such as a handover.

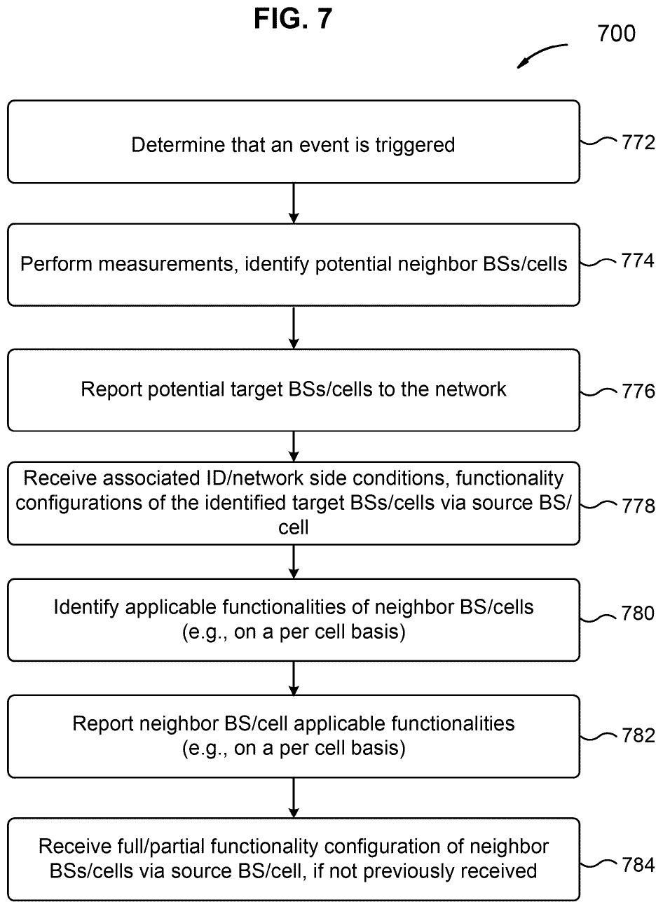

FIG. 7 is a flowchart diagram illustrating a method/process 700 performed by a UE for identifying and reporting applicable functionalities for one or more neighboring cells, in accordance with an example implementation of the present disclosure.

As shown in FIG. 7, in step 772, the UE determines that a reporting event is triggered. For example, a legacy mobility event (e.g., Events A3, A5, etc.) has been triggered.

In step 774, in response to the legacy mobility event, the UE performs measurements and identifies potential neighboring or target BSs/cells.

In step 776, the UE reports the identified potential neighboring or target BSs/cells to the network.

In step 778, the UE receives from the source BS/cell one or more associated IDs, network-side conditions, functionality configurations of the identified potential neighboring or target BSs/cells via the source BS/cell. In some implementations, step 778 may substantially correspond to step 452 in FIG. 4, the details of which are omitted for brevity. In the present implementation, the receipt of the configuration(s) in step 778 is in response to the event (e.g., legacy Events A2, A3, A5, etc.) triggered in step 772.

In step 780, the UE then identifies the applicable functionalities of each of the identified target or neighboring BSs/cells (e.g., on a per cell basis). In one implementation, step 780 may substantially correspond to step 454 in FIG. 4, the details of which are omitted for brevity.

In step 782, the UE reports the applicable functionalities (e.g., using functionality IDs) on a per cell basis to the source and/or neighboring BSs/cells, for example, using L1/L2 signaling, such as via RRC signaling.

In step 784, the UE receives full or partial functionality configurations of the neighboring BSs/cells via the source BS/cell, if the functionality configurations were not previously received (e.g., in step 772 or 778).

In some implementations, the source and neighboring BSs exchange applicable functionality information using a gNB-to-gNB interface such as Xn interface. After sending the measurement report, the UE waits for the source BS's handover decision based on the measurement report.

### Receiving Handover Command

Upon handover decision, the source BS/cell sends an RRC connection reconfiguration (RRCConnectionReconfiguration) message containing details of the target BS/cell and radio resources. In one implementation, the RRCConnectionReconfiguration message may include full or partial functionality configurations (e.g., AI/ML functionality configurations) of the one or more potential target or neighboring BSs/cells on a per cell basis. In another implementation, a target or neighboring BS/cell may provide multiple functionality configurations.

In another implementation, the target or neighboring BS/cell may provide a default configuration (e.g., an inference configuration) or select an appropriate configuration that the UE may activate as soon as the handover is complete.

In another implementation, if a single functionality configuration is provided by the target or neighboring BSs/cells, then upon selection of the target BS/cell, the UE may implicitly apply the functionality configuration provided by the selected BS.

An RRC message (e.g., RRC Reconfiguration with ReconfigurationWithSync (HO Command)) may indicate an initial state of a functionality (e.g., an AI/ML functionality), for example whether to active the available functionality immediately or after a handover is complete. The BS/cell or the network may have the option not to activate the functionality in the initial state.

Based on the received neighboring BS/cell functionality information (e.g., AI/ML functionality information), the UE may identify one or more applicable functionalities and report them to the source BS/cell. The UE may report the applicable functionalities via a new RRC message, within enhanced measurement reporting, or an extended UAI message.

The source BS/cell may report the applicable functionalities to the neighboring BS/cell using a gNB-to-gNB interface, such as an Xn interface. Upon receiving the applicable functionality information, the neighboring BSs/cells may provide the applicable functionality configurations (full or partial) to the source BS/cell which may then send the configurations to the UE in a new RRC message or in the HO command.

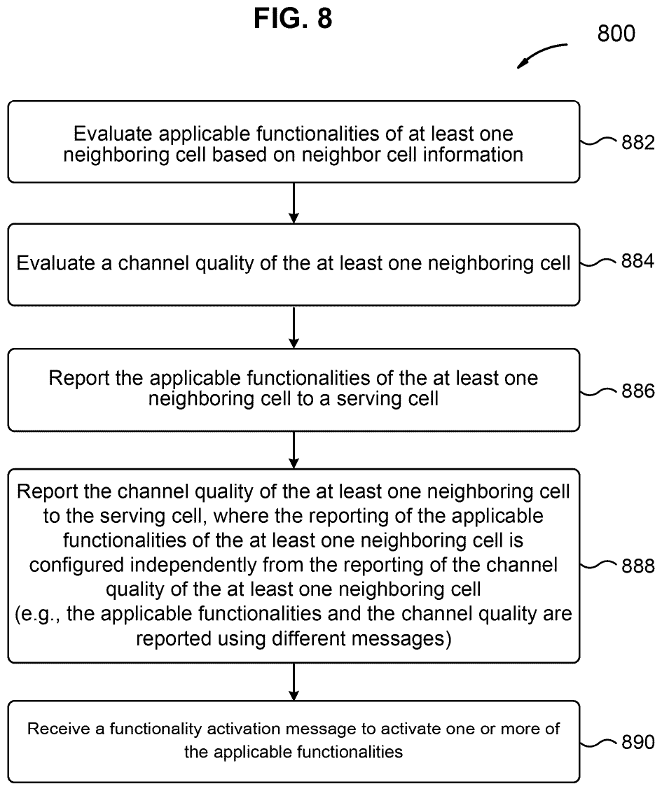

FIG. 8 is a flowchart diagram illustrating a method/process 800 performed by a UE for independently reporting signal quality and applicable functionalities, in accordance with an example implementation of the present disclosure. In step 882, the UE evaluates applicable functionalities of at least one neighboring cell based on neighboring cell information provided by the network (e.g., via a serving BS/cell). In step 884, the UE evaluates a signal (or channel) quality of the at least one neighboring cell. In step 886, the UE reports the applicable functionalities of the at least one neighboring cell to the serving BS/cell. In step 888, the UE reports the signal (or channel) quality of the at least one neighboring cell to the serving cell, where the reporting of the applicable functionalities of the at least one neighboring cell is configured independently from the reporting of the signal (or channel) quality of the at least one neighboring cell. For example, the applicable functionalities and the channel quality are reported using different messages. In step 890, the UE receives a functionality activation message to activate one or more of the applicable functionalities.

According to an aspect of the present disclosure, the UE reports the applicable functionalities on a per cell basis for source and/or neighboring BSs/cells. The UE may report applicable functionalities of one or more cells using a new RRC message, within enhanced measurement reporting, or using an extended UAI.

### Option 1: Enhanced UAI Message

The UE can report neighboring BS/cell applicable functionalities of one or more neighboring BSs/cells using enhanced UAI message with neighboring BS/cell applicable functionalities.

According to one implementation, upon initiating the procedure, the UE shall:
if configured to provide neighboring BS/cell AI/ML functionality report:
if the UE did not transmit a UEAssistanceInformation message with neighboring BS/cell AI/ML functionality report since it was configured to provide neighboring BS/cell AI/ML functionality report;
2> if the current neighboring BS/cell AI/ML functionality report is different from the one indicated in the last transmission of the UEAssistanceInformation message including neighboring BS/cell AI/ML functionality report;
   3> initiate transmission of the enhanced UEAssistanceInformation message in accordance with Section 5.7.4.3 of the 3GPP technical specification TS 38.331 to provide a neighboring BS/cell AI/ML functionality report (this may include for example functionality IDs of the neighboring cell).

According to another implementation, the UE may indicate one or more preferred neighboring BSs/cells and/or applicable functionalities. An example is shown below:
1> if the UE has one or more neighboring BSs/cells and one or more preferred Functionalities:
2> if the UE has a preference in being provisioned with neighboring BSs/cells information:
   3> set neighboring BSs/cells Preference to true; 2> else: 3> set neighboring BSs/cells Preference to false;
2> if the UE has a preference in being provisioned with preferred functionalities information:
   3> set preferred functionalities Preference to true;
2> else:
   3> set preferred functionalities to false.

This modification reflects the UE's preferences for both neighboring BSs/cells and preferred functionalities information when transmitting the UEAssistanceInformation message.

Implementation example 1 of a structure for a new NeighborCell Functionality Reporting information element (IE) is shown below:

-- ASN1START
-- TAG-FUNCTIONALITY-START
NeighborCellFunctionality ::= SEQUENCE {

| | |
|---|---|
| applicableFunctionalityList | SEQUENCE (SIZE (1..maxNrofFunctionsPerCell)) OF |
| FunctionalityId | OPTIONAL -Indicates functionalities and corresponding |

Neighbor gNBSs/cells.

| | |
|---|---|
| featureEnabled/Initial State of the functionality | BOOLEAN, -- Indicates whether the |

functionality is enabled

| | |
|---|---|
| featureEnabled/Activation request of the functionality | BOOLEAN, -- Indicates whether the |

functionality is activated in Handover (HO) command or after HO

| | |
|---|---|
| featurePreference of functionality | BOOLEAN, -- Indicates if multiple functionalities are |

reported for a single gNB/cell, preferred functionality maybe included.

| | |
|---|---|
| maxOperationDuration | INTEGER (1..1024), -- Maximum duration of the functionality in/How long |

the functionality is valid milliseconds/Validity

| | |
|---|---|
| adaptiveControlSupported | BOOLEAN, -- Indicates if adaptive control for the functionality is |

supported

| | |
|---|---|
| functionalityModelType | ENUMERATED {A, B, C}, -- Represents the modelType of functionality |

which model is used

| | |
|---|---|
| functionalityThreshold | INTEGER (0..100), -- Threshold to trigger or adjust the functionalityreporting |

conditions/parameters in percentage

| | |
|---|---|
| functionalityThreshold Trigger | INTEGER (0..100), -- Threshold or trigger or conditions that led to |

reporting of the functionality report (reporting cause).

| | |
|---|---|
| dynamicSupport | BOOLEAN -- Indicates if the UE supports dynamic adjustments for this |

functionality
}
-- TAG-FUNCTIONALITY-STOP
-- ASN1STOP

Implementation example 2 of a structure for a new NeighborCell Functionality Reporting information element (IE) is shown below:

-- ASN1START
-- TAG-RRCMESSAGE-START
UEAssistanceInformation ::= SEQUENCE {

| | |
|---|---|
| neighborCellFunctionalityList | SEQUENCE (SIZE (1..maxNeighborCells)) OF |

NeighborCellFunctionality,

| | |
|---|---|
| rrcTransactionIdentifier | INTEGER (0..3) -- Transaction ID used for tracking RRC procedures |

}
NeighborCellFunctionality ::= SEQUENCE {

| | |
|---|---|
| applicableFunctionalityList | SEQUENCE (SIZE (1..maxFunctionality)) OF FunctionalityId, -- List of |

functionalities and associated Neighbor gNBSs/cells

| | |
|---|---|
| featureInitialState | BOOLEAN, -- Indicates whether the functionality is initially enabled |
| featureActivationRequest | BOOLEAN, -- Indicates whether functionality activation is requested |

in HO command or post-HO

| | |
|---|---|
| featurePreference | BOOLEAN OPTIONAL, -- Indicates the preferred functionality if multiple |

functionalities are reported for a single gNB/cell

| | |
|---|---|
| maxOperationDuration | INTEGER (1..1024), -- Maximum duration in milliseconds for the |

functionality to remain valid

| | |
|---|---|
| adaptiveControlSupported | BOOLEAN, -- Indicates if adaptive control is supported for the |

functionality

| | |
|---|---|
| functionalityModelType | ENUMERATED {modelA, modelB, modelC}, -- Model type of |

functionality (e.g., which model is used for processing or optimization)

| | |
|---|---|
| functionalityThreshold | INTEGER (0..100), -- Threshold to trigger or adjust the functionality (in |

percentage)

| | |
|---|---|
| functionalityThresholdTrigger | ENUMERATED {signalStrength, load, delay} OPTIONAL, -- |

Conditions that led to the functionality report (trigger cause)

| | |
|---|---|
| dynamicSupport | BOOLEAN -- Indicates if the UE supports dynamic adjustments for this |

functionality
}
FunctionalityId :: = ENUMERATED {id1, id2, id3, id4, id5, id6, id7, id8, id9, id10}
-- TAG-RRCMESSAGE-STOP
--ASN1STOP

Example detailed parameters for the functionality report may include a neighboring cell functionality list (NeighborCellFunctionalityList) and a functionality ID (FunctionalityId).

A neighboring cell functionality list (NeighborCellFunctionalityList) is a list that contains multiple NeighborCellFunctionality elements, each corresponding to a different neighboring BS or cell. The NeighborCellFunctionality elements may include the following:
applicableFunctionalityList: Lists the functionalities applicable to the neighbor gNBs or cells.
featureInitialState: Indicates whether the functionality is enabled when first configured or in the idle/inactive state.
featureActivationRequest: Shows whether the functionality is requested for activation in the handover command or after handover or no preference.
featurePreference: This optional field indicates the preferred functionality if multiple functionalities are available for the same neighboring BS/cell.
maxOperationDuration: Specifies how long the functionality remains valid after being activated.
adaptiveControlSupported: Indicates if the functionality can adapt dynamically based on conditions such as network load or UE state.
functionalityModelType: Describes the type of model (e.g., Model A, B, or C) used for the functionality.
functionalityThreshold: Specifies the threshold at which the functionality is triggered or adjusted or Reason for reporting/why the functionality reporting was triggered.
functionalityThresholdTrigger: Optional field that defines the specific event or condition (e.g., signal strength, load, or delay, KPI thresholds) that triggered the functionality reporting.
dynamicSupport: Indicates whether the UE supports dynamic adjustment of the functionality.

Other similar related parameters may also be included, for example, the reason for the update (e.g., network conditions, UE capabilities, UE internal conditions, AI/ML model validity, version etc.), applicability status (applicable/inapplicable), and recommended actions (e.g., beam selection, resource allocation, request to change functionality configuration, preferred functionality configuration, Functionality (de-) activation request).

The functionality IDs (FunctionalityIds) enumerate the available functionalities that can be applied to the neighboring BS/cell. Table 2 below shows examples of different functionalities associated with different neighboring cells.

TABLE 2
Applicable Functionalities for Neighboring Cells

| | | | Activation |
|---|---|---|---|
| | | | Preference |
| | | | (e.g., based on |
| Applicable | neighboring | | UE-side |
| Functionality | cell ID | Preference | conditions) |
| F1, F2 | A | F1 | In HO command |
| F2, F3 | B | F2 | After HO is |
| | | | complete |
| F4, F1 | C | F4 | In HO command |

In Table 2 above, F1 and F2 are the applicable functionalities for neighboring cell A, the UE indicates that its preferred functionality to activate is applicable functionality F1. The UE may also indicate its preference to when and how to activate the applicable functionality for example, to receive functionality activation indication in a HO command, after the handover is complete, or in a separate L1/L2/L3 signaling indication (e.g., in a RRC message or a MAC CE).

### Option 2: Using a New RRC Message or MeasReport.

The UE can report the applicable functionalities of neighboring BS/cell using a new RRC message (e.g., an RRC request, RRC setup, etc.) or a measurement report (MeasReport).

The measurement results (MeasResults) information element below includes measured results for intra-frequency, inter-frequency, inter-RAT mobility and measured results for NR sidelink communication/discovery.

MeasResults information element
-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | OCTET STRING -- Contains PC5 SL- |

MeasResultListRelay-r17

| | |
|---|---|
| applicableFunctionalityList | SEQUENCE (SIZE (1..maxNrofFunctionsPerCell)) OF |
| FunctionalityId | OPTIONAL |

}
-- TAG-MEASRESULTS-STOP
-- ASN1STOP

The following is an example implementation of a measurement report.

-- ASN1START
-- TAG-MEASUREMENTREPORT-START
MeasurementReport ::= SEQUENCE {

| | |
|---|---|
| measResults | MeasResults, -- Standard measurement results (e.g., RSRP, RSRQ, etc.) |
| neighborCellFunctionalityList | SEQUENCE (SIZE (1..maxNeighborCells)) OF |
| NeighborCellFunctionality | OPTIONAL -- New section for reporting neighboring cell Functionality |

}
NeighborCellFunctionality ::= SEQUENCE {

| | |
|---|---|
| applicableFunctionalityList | SEQUENCE (SIZE (1..maxFunctionality)) OF FunctionalityId, -- List of |

functionalities and associated Neighbor gNBSs/cells

| | |
|---|---|
| featureInitialState | BOOLEAN, -- Indicates whether the functionality is initially enabled |
| featureActivationRequest | BOOLEAN, -- Indicates whether functionality activation is requested |

in HO command or post-HO

| | |
|---|---|
| featurePreference | BOOLEAN OPTIONAL, -- Indicates the preferred functionality if multiple |

functionalities are reported for a single gNB/cell

| | |
|---|---|
| maxOperationDuration | INTEGER (1..1024), -- Maximum duration in milliseconds for the |

functionality to remain valid

| | |
|---|---|
| adaptiveControlSupported | BOOLEAN, -- Indicates if adaptive control is supported for the |

functionality

| | |
|---|---|
| functionalityModelType | ENUMERATED {modelA, modelB, modelC}, -- Model type of |

functionality (e.g., which model is used for processing or optimization)

| | |
|---|---|
| functionalityThreshold | INTEGER (0..100), -- Threshold to trigger or adjust the functionality (in |

percentage)

| | |
|---|---|
| functionalityThresholdTrigger | ENUMERATED {signalStrength, load, delay} OPTIONAL, -- |

Conditions that led to the functionality report (trigger cause)

| | |
|---|---|
| dynamicSupport | BOOLEAN -- Indicates if the UE supports dynamic adjustments for this |

functionality
}
FunctionalityId ::= ENUMERATED {id1, id2, id3, id4, id5, id6, id7, id8, id9, id10}
MeasResults ::= SEQUENCE {

| | |
|---|---|
| measId | INTEGER (1..maxMeasId), -- Measurement ID from the config |
| measResultServCell | ServCellMeasResult, -- Measurement results for serving cell |
| measResultNeighCells | SEQUENCE (SIZE (1..maxNeighborCells)) OF NeighCellMeasResult, |

-- Measurement results for neighboring cells
}
-- TAG-MEASUREMENTREPORT-STOP
-- ASN1STOP

The following is an example implementation of an RRC connection request message.

-- ASN1START
-- TAG-RRCMESSAGE-START
RRCConnectionRequest ::= SEQUENCE {
...

| | |
|---|---|
| ueId | INTEGER (0..65535), -- Unique identifier for the UE |

...

| | |
|---|---|
| ueAssistanceInformation | [0] UEAssistanceInformation OPTIONAL, -- Optional field for UE |

assistance information
...
}
UEAssistanceInformation ::= SEQUENCE {

| | |
|---|---|
| neighborCellFunctionalityList | SEQUENCE (SIZE (1..maxNeighborCells)) OF |

NeighborCellFunctionality,

| | |
|---|---|
| rrcTransactionIdentifier | INTEGER (0..3) -- Transaction ID used for tracking RRC procedures |

}
NeighborCellFunctionality :: = SEQUENCE {

| | |
|---|---|
| applicableFunctionalityList | SEQUENCE (SIZE (1..maxFunctionality)) OF FunctionalityId, -- List of |

functionalities and associated Neighbor gNBSs/cells

| | |
|---|---|
| featureInitialState | BOOLEAN, -- Indicates whether the functionality is initially enabled |
| featureActivationRequest | BOOLEAN, -- Indicates whether functionality activation is requested |

in HO command or post-HO

| | |
|---|---|
| featurePreference | BOOLEAN OPTIONAL, -- Indicates the preferred functionality if multiple |

functionalities are reported for a single gNB/cell

| | |
|---|---|
| maxOperationDuration | INTEGER (1..1024), -- Maximum duration in milliseconds for the |

functionality to remain valid

| | |
|---|---|
| adaptiveControlSupported | BOOLEAN, -- Indicates if adaptive control is supported for the |

functionality

| | |
|---|---|
| functionalityModelType | ENUMERATED {modelA, modelB, modelC}, -- Model type of |

functionality (e.g., which model is used for processing or optimization)

| | |
|---|---|
| functionalityThreshold | INTEGER (0..100), -- Threshold to trigger or adjust the functionality (in |

percentage)

| | |
|---|---|
| functionalityThresholdTrigger | ENUMERATED {signalStrength, load, delay} OPTIONAL, -- |

Conditions that led to the functionality report

| | |
|---|---|
| dynamicSupport | BOOLEAN, -- Indicates if the UE supports dynamic adjustments for this |

functionality

| | |
|---|---|
| updateReason | ENUMERATED {networkConditions, ueCapabilities, |

ueInternalConditions, aiMIModelValidity, version} OPTIONAL -- Reason for the update
}
FunctionalityId ::= ENUMERATED {id1, id2, id3, id4, id5, id6, id7, id8, id9, id10}
-- TAG-RRCMESSAGE-STOP
-- ASN1STOP

The following is an example implementation of an RRC connection setup message.

RRCConnectionSetup
-- ASN1START
-- TAG-RRCMESSAGE-START
RRCConnectionSetup ::= SEQUENCE {
...

| | |
|---|---|
| cellId | INTEGER (0..268435455), -- Cell ID of the serving cell |

...

| | |
|---|---|
| ueAssistanceInformation | [0] UEAssistanceInformation OPTIONAL, -- Optional field for UE |

assistance information
...
}
-- TAG-RRCMESSAGE-STOP
-- ASN1STOP

The following is an example implementation of a dedicated RRC message.

### Dedicated RRC Message

-- ASN1START
-- TAG-RRCMESSAGE-START
NeighborCellFunctionalityMessage ::= SEQUENCE {

| | |
|---|---|
| rrcTransactionIdentifier | INTEGER (0..3), -- Transaction ID used for tracking RRC procedures |
| neighborCellFunctionalityList | SEQUENCE (SIZE (1..maxNeighborCells)) OF |

NeighborCellFunctionality -- List of functionalities for neighboring gNBSs/cells
}
NeighborCellFunctionality ::= SEQUENCE {

| | |
|---|---|
| applicableFunctionalityList | SEQUENCE (SIZE (1..maxFunctionality)) OF FunctionalityId, -- List of |

functionalities applicable to the neighbor gNBSs/cells

| | |
|---|---|
| featureInitialState | BOOLEAN, -- Indicates whether the functionality is initially enabled |
| featureActivationRequest | BOOLEAN, -- Indicates if functionality activation is requested in HO |

command or post-HO

| | |
|---|---|
| featurePreference | BOOLEAN OPTIONAL, -- Indicates the preferred functionality if multiple |

functionalities are reported for a single gNB/cell

| | |
|---|---|
| maxOperationDuration | INTEGER (1..1024), -- Maximum duration in milliseconds for the |

functionality to remain valid

| | |
|---|---|
| adaptiveControlSupported | BOOLEAN, -- Indicates if adaptive control is supported for the |

functionality

| | |
|---|---|
| functionalityModelType | ENUMERATED {modelA, modelB, modelC}, -- Model type of |

functionality

| | |
|---|---|
| functionalityThreshold | INTEGER (0..100), -- Threshold to trigger or adjust the functionality (in |

percentage)

| | |
|---|---|
| functionalityThresholdTrigger | ENUMERATED {signalStrength, load, delay} OPTIONAL, -- |

Conditions that led to the functionality report

| | |
|---|---|
| dynamicSupport | BOOLEAN, -- Indicates if the UE supports dynamic adjustments for this |

functionality

| | |
|---|---|
| updateReason | ENUMERATED {networkConditions, ueCapabilities, |

ueInternalConditions, aiMIModelValidity, version} OPTIONAL -- Reason for the update
}
FunctionalityId ::= ENUMERATED {id1, id2, id3, id4, id5, id6, id7, id8, id9, id10}
-- TAG-RRCMESSAGE-STOP
-- ASN1STOP

It should be noted that implementations of RRC messaging are not limited to the above example messages or IEs, and other related parameters may also be included.

### Option 3: Hybrid Approach

A hybrid approach can be used where source gNB/cell related information may be sent using UAI and neighboring BS/cell related information may be sent in a different RRC message such as Measurement Report or a dedicated RRC message.

In another implementation, a part of neighboring cell information may be sent in UAI and the remaining part maybe sent in any other RRC message such as a dedicated RRC message etc.

The following is an example implementation of a measurement configuration (MeasConfig) IE, which specifies measurements to be performed by the UE, and covers intra-frequency, inter-frequency and inter-RAT mobility as well as configuration of measurement gaps.

MeasConfig information element
-- ASN1START
-- TAG-MEASCONFIG-START

| MeasConfig ::= | SEQUENCE { | |
|---|---|---|
| measObjectToRemoveList | MeasObjectToRemoveList | OPTIONAL, |

-- Need N

| | | |
|---|---|---|
| measObjectToAddModList | MeasObjectToAddModList | OPTIONAL, |

-- Need N

| | | |
|---|---|---|
| reportConfigToRemoveList | ReportConfigToRemoveList | OPTIONAL, |

-- Need N

| | | |
|---|---|---|
| reportConfigToAddModList | ReportConfigToAddModList | OPTIONAL, |

-- Need N

| | | |
|---|---|---|
| measIdToRemoveList | MeasIdToRemoveList | OPTIONAL, -- |

Need N

| | | |
|---|---|---|
| measIdToAddModList | MeasIdToAddModList | OPTIONAL, -- |

Need N

| s-MeasureConfig | CHOICE { | |
|---|---|---|
| ssb-RSRP | RSRP-Range, | |
| csi-RSRP | RSRP-Range | |
| } | | OPTIONAL, -- Need M |
| quantityConfig | QuantityConfig | OPTIONAL, -- Need M |
| measGapConfig | MeasGapConfig | OPTIONAL, -- Need |

M

| | | |
|---|---|---|
| measGapSharingConfig | MeasGapSharingConfig | OPTIONAL, - |

```
- Need M
  ...,
  [[
```

| | | |
|---|---|---|
| interFrequencyConfig-NoGap-r16 | ENUMERATED {true} | OPTIONAL |

```
-- Need R
  ]],
  [[
```

| | |
|---|---|
| effectiveMeasWindowConfig-r18 | SetupRelease {MeasWindowConfig-r18} |

```
OPTIONAL -- Need M
  ]]
      [[
```

| | |
|---|---|
| functionalityConfigToAddModList | FunctionalityConfigToAddModList |

OPTIONAL, -- Need N

| | |
|---|---|
| functionalityConfigToRemoveList | FunctionalityConfigToRemoveList |

OPTIONAL, -- Need N
}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF ReportConfigId |

-- TAG-MEASCONFIG-STOP
-- ASN1STOP

The following is implementation of a an example FunctionalityConfigToAddModList IE, which specifies a list of functionalities to be evaluated by the UE if the provided functionalities are applicable functionalities.

FunctionalityConfigToAddModList information element
-- ASN1START
-- TAG-MEASCONFIG-START

| | |
|---|---|
| FunctionalityConfigToAddModList ::= | SEQUENCE (SIZE (1..maxNrofFunc)) OF |

FunctionalityConfigToAddMod

| | |
|---|---|
| FunctionalityConfigToAddMod ::= | SEQUENCE { |
| functionalityId | FunctionalityId, |
| associatedId | AssociatedId, |
| trainingConfig | TrainingConfig |

| | |
|---|---|
| inferenceConfig | InferenceConfig |

OPTIONAL, -- Need R

| | |
|---|---|
| reportConfig | reportConfig |

OPTIONAL, -- Need R
}
-- TAG-MEASCONFIG-STOP
-- ASN1STOP

The following is an example implementation of a MeasObjectNR IE, which specifies information applicable for SS/PBCH block(s) intra/inter-frequency measurements and/or CSI-RS intra/inter-frequency measurements.

MeasObjectNR information element
-- ASN1START
-- TAG-MEASOBJECTNR-START

| MeasObjectNR ::= | SEQUENCE { | |
|---|---|---|
| ssbFrequency | ARFCN-ValueNR | OPTIONAL, -- Cond |

SSBorAssociatedSSB

| | |
|---|---|
| ssbSubcarrierSpacing | SubcarrierSpacing |
| CellsToAddMod ::= | SEQUENCE { |
| physCellId | PhysCellId, |
| cellIndividualOffset | Q-OffsetRangeList |
| functionalityIds-v1900 | SEQUENCE (SIZE (1..maxNrofFunctionsPerCell)) OF |
| FunctionalityId | OPTIONAL -- Need R |

-- TAG-MEASOBJECTNR-STOP
-- ASN1STOP

The following is an example implementation of a MeasResults IE, which covers measured results for intra-frequency, inter-frequency, inter-RAT mobility and measured results for NR sidelink communication/discovery.

MeasResults information element
-- ASN1START
-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | OCTET STRING -- Contains PC5 SL- |

MeasResultListRelay-r17

| | |
|---|---|
| applicableFunctionalityList | SEQUENCE (SIZE (1..maxNrofFunctionsPerCell)) OF |
| FunctionalityId | OPTIONAL |

}
-- TAG-MEASRESULTS-STOP
-- ASN1STOP

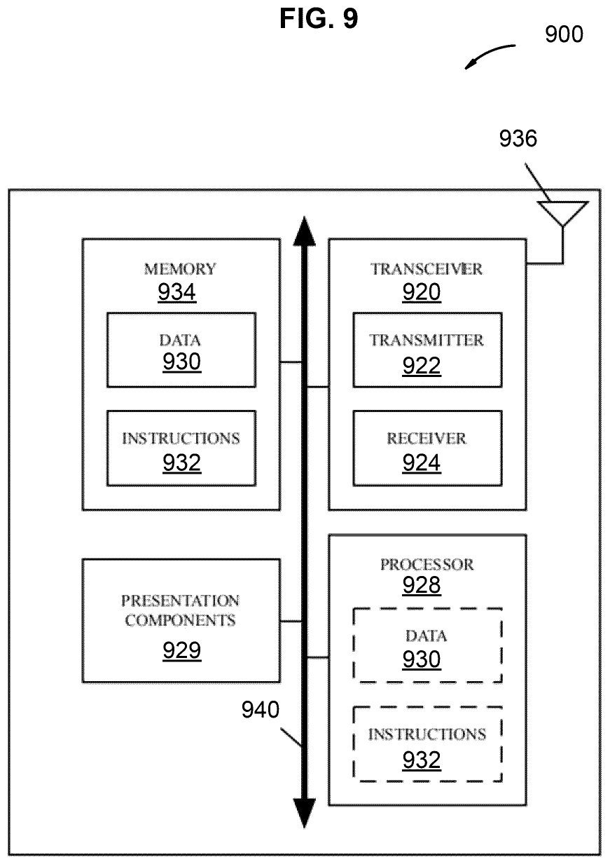

FIG. 9 is a block diagram illustrating a node 900 for wireless communication, in accordance with an example implementation of the present disclosure. As illustrated in FIG. 9, the node 900 may include a transceiver 920, a processor 928, a memory 934, one or more presentation components 929, and at least one antenna 936. The node 900 may also include a radio frequency (RF) spectrum band module, a BS communications module, a network communications module, and a system communications management module, Input/Output (I/O) ports, I/O components, and a power supply (not illustrated in FIG. 9).

Each of the components may directly or indirectly communicate with each other over one or more buses 940. The node 900 may be a UE, a BS, a LMF server, or any other network node on the RAN side or CN side that performs various functions disclosed with reference to FIGS. 1 through 8.

The transceiver 920 has a transmitter 922 (e.g., transmitting/transmission circuitry) and a receiver 924 (e.g., receiving/reception circuitry) and may be configured to transmit and/or receive time and/or frequency resource partitioning information. The transceiver 920 may be configured to transmit in different types of subframes and slots including, but not limited to, usable, non-usable, and flexibly usable subframes and slot formats. The transceiver 920 may be configured to receive data and control channels.

The node 900 may include a variety of computer-readable media. Computer-readable media may be any available media that may be accessed by the node 900 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 934 may include computer-storage media in the form of volatile and/or non-volatile memory. The memory 934 may be removable, non-removable, or a combination thereof. Example memory may include solid-state memory, hard drives, optical-disc drives, etc. As illustrated in FIG. 9, the memory 934 may store a computer-readable and/or computer-executable instructions 932 (e.g., software codes) that are configured to, when executed, cause the processor 928 to perform various functions disclosed herein, for example, with reference to FIGS. 1 through 10. Alternatively, the instructions 932 may not be directly executable by the processor 928 but may be configured to cause the node 900 (e.g., when compiled and executed) to perform various functions disclosed herein.

The processor 928 (e.g., having processing circuitry) may include an intelligent hardware device, e.g., a Central Processing Unit (CPU), a microcontroller, an ASIC, etc. The processor 928 may include memory. The processor 928 may process the data 930 and the instructions 932 received from the memory 934, and information transmitted and received via the transceiver 920, the baseband communications module, and/or the network communications module. The processor 928 may also process information to send to the transceiver 920 for transmission via the antenna 936 to the network communications module for transmission to a CN.

One or more presentation components 929 may present data indications to a person or another device. Examples of presentation components 929 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment may also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive cell information, via a serving cell, the cell information comprising one or more network-side conditions and an associated identifier (ID) of at least one cell;
evaluate one or more functionalities of the at least one cell based on the cell information;
report evaluation results of the one or more functionalities of the at least one cell to the serving cell.

2. The UE of claim 1, wherein the at least one processor is further configured to execute the one or more computer-executable instructions to cause the UE to:
receive one or more functionality key performance indicator (KPI) thresholds associated with the one or more functionalities of at least one cell;
determine whether a reporting event is triggered based on at least one of the one or more functionality KPI thresholds, mobility scenarios, and UE-specific parameters, scenarios and conditions;
wherein the reporting of the evaluation results is in response to the reporting event being triggered.

3. The UE in claim 2, wherein the one or more functionality KPI thresholds comprise artificial intelligence/machine learning (AI/ML) functionality KPI thresholds.

4. The UE in claim 1, wherein the evaluation results of the one or more functionalities are reported to the serving cell in response to a change in an observed artificial intelligence/machine learning (AI/ML) functionality KPI range.

5. The UE of claim 1, wherein the at least one processor is further configured to execute the one or more computer-executable instructions to cause the UE to:
prior to receiving the cell information, send a measurement report to the serving cell in response to a triggering event.

6. The UE in claim 5, wherein the measurement report includes measurements of channel quality of the at least one cell.

7. The UE in claim 1, wherein the evaluation results of the one or more functionalities are reported to the serving cell in response to:
a measurement parameter of the serving cell falling below a first threshold, or
a measurement parameter of the at least one cell exceeding a second threshold.

8. The UE in claim 1, wherein the at least one cell comprises the serving cell.

9. The UE in claim 1, wherein the at least one cell comprises a neighboring cell.

10. The UE in claim 1, wherein the cell information further comprises one or more functionality configurations of the at least one cell.

11. The UE in claim 1, wherein the UE evaluates the one or more functionalities of the at least one cell based on at least one of:
one or more functionality KPI thresholds,
one or more associated IDs,
the one or more network-side conditions,
functionality or inference configurations,
the UE's internal parameters, and
model availability.

12. The UE in claim 1, wherein the evaluation results comprise an indication of whether at least one of the one or more functionalities is a functionality applicable for the at least one cell.

13. The UE of claim 1, wherein the at least one processor is further configured to execute the one or more computer-executable instructions to cause the UE to:
receive one or more functionality key performance indicator (KPI) thresholds associated with the one or more functionalities of at least one cell;
evaluate one or more functionality KPI thresholds;
accept or reject the one or more functionality KPI thresholds based on the evaluation.

14. The UE of claim 1, wherein the at least one processor is further configured to execute the one or more computer-executable instructions to cause the UE to:
monitor a functionality key performance indicator (KPI) range of at least one of the one or more functionalities.

15. A method by a user equipment (UE), the method comprising:
receiving cell information via a serving cell, the cell information comprising one or more network-side conditions and an associated identifier (ID) of at least one cell;
evaluating one or more functionalities of the at least one cell based on the cell information;
reporting evaluation results of the one or more functionalities of the at least one cell to the serving cell.
